(19) United States
(12) Patent Application Publication
(10) Pub. No.: US 2016/0338546 A1
(43) Pub. Date: Nov. 24, 2016

(54) REMOTE CONTROLLABLE SEMI-AUTOMATED METHOD AND SYSTEM FOR PREPARING FOOD

(71) Applicant: Umm Al-Qura University, Makkah (SA)

(72) Inventors: Noman Ahmed Shah, Makkah (SA); Imran Ahmed Shah, Lahore (PK); Kamran Ahmed Shah, Leeds (GB)

(73) Assignee: Umm Al-Qura University

(21) Appl. No.: 14/718,272

(22) Filed: May 21, 2015

(51) Int. Cl. A47J 44/00

(52) U.S. Cl. CPC A47J 44/00

(57) ABSTRACT

A semi-automated or fully automated method for preparing foods are described. In a first step the method calls for providing a computer having a data storage, an input mechanism for inputting a plurality of food selections and their locations as well as alternative menus in the data storage, a processing control unit and a display unit for displaying the available food items and alternative menus. The method also incorporates food processing equipment including a mixer, a microwave oven, a conventional oven and preferably a warming oven as well as a 3D food printer, a timer and a mechanism for issuing signals. Further, the method includes the step of providing a remote control operatively connected to the computer for displaying items in inventory, alternative menus and cooking instructions as well as a mechanism for activating the processing control unit as well as food processing equipment for preparing selected items.

### FIELD OF THE INVENTION

This invention relates to a remotely controllable semi-automated and/or fully automated method and system for preparing food and more particularly to a method and system for preparing individual or multi-person meals.

### BACKGROUND OF THE INVENTION

Automated and semi-automated food processing equipment is well known and has been in use for many years. For example, a Manufacturing Method of Three-Dimensional Food By Rapid Prototyping is disclosed in a U.S. Patent Application Publication No. 2008/0260918 of Lai et al. As disclosed, a manufacturing method for producing three-dimensional food in a very short time without using a mold. The key technology is to establish a figure or word character in computer-aided design (CAD) software such as CATIA, Pro/E, I-Deals, Solidwork, and AutoCAD or use a built-in figure and word of the Window system. The figure or word character is built into a three-dimensional model and transformed into a file with an *.stl format. Finally, a rapid prototyping (RP) machine is used to build the 3D food, and then the finished goods of the 3D food are produced. The invention promotes the food manufacturing method from 2D to 3D and accomplishes substantial progress on the application of rapid prototyping.

A more recent U.S. Pat. No. 8,145,854 of Lee discloses a Method And Apparatus For Controlling Automated Food Preparation Systems. As disclosed, the method and apparatus are presented for automatically generating machine control instructions for controlling automated food preparation systems and equipment from ordinary recipes in natural language. The invention allows the sharing, remote execution, scheduling, and automatic ingredient ordering for such recipes to allow professional food preparation with little or no human intervention.

Finally, a U.S. Pat. No. 8,712,851 of Koether et al. discloses a Diagnostic Data Interchange wherein a bi-directional communication network provides monitoring, data collection and control of food service industry operations. The system includes a computer and control logic implemented by the computer which may be configured to perform various tasks. A communication network may be provided linking the computer with equipment and appliances having a microprocessor based controller capable of communicating with the system. In one embodiment, the system automatically verifies the performance of equipment-related manual tasks in food preparation. In another embodiment, the system schedules the maintenance of a plurality of kitchen appliances. In another embodiment, the system provides a hold timer for tracking the hold time of cooked food products and determines when the hold time elapses. In yet another embodiment, the system manages the inventory of cooked food products in a food preparation establishment.

Notwithstanding the above, it is presently believed that there is a need for a remote controllable semi-automated method and system for preparing food items and/or meals for one or more persons.

### SUMMARY OF THE INVENTION

In essence, the invention contemplates a remote controllable semi-automated and/or fully automated system for preparing food items as for example a means for one or more persons. The system comprises or consists of a computer having data storage, a data storage module and an input device such as a keyboard, a processing control unit and a display unit for displaying available items in inventory and alternative menus for such items. The system also includes food processing equipment including a mixer, a microwave oven, a conventional oven as well as a warming oven and a 3D food printer. A remote control is operatively connected to the computer for displaying a list of food items and/or food kits in inventory and alternative menus for such items and for initiating the processing control unit and the food processing equipment. The system also includes a refrigerator and a freezer for storing food items required for one or more pre-planned means. In addition, a real time remote auditing program for indicating available food kits and equipment for preparing a meal and the number of each food kit in inventory.

The system further comprises or consists of a signal indicating mechanism for indicating when a meal is ready and a monitoring program for indicating the status of a meal and a program for automatically cleaning the food processing equipment after a preselected number of cycles. A further embodiment of the invention contemplates a semi-automated method for preparing food items. The method comprises or consists of the following steps. The steps comprise or consist of providing a computer having data storage, an input mechanism for inputting a plurality of food items, the locations of said items and alternative menus and cooking instructions for each menu in data storage, a processing control unit and a display unit for displaying the available food items and quantities and menus in inventory.

The method also includes the step of providing food processing equipment including mixer, a microwave oven, a conventional oven and a warming oven, a 3D food printer, a timer and a mechanism for signaling that food items are ready for delivery.

In addition, the method includes the step of activating the processing control unit and the food processing equipment for preparing the selected food items as well as a remote auditing program for testing and auditing the performance of the control unit and food processing equipment.

Finally, the method includes the steps of providing an auditing program for checking that the food items were properly prepared.

In the aforementioned method a further step may provide a handling step for frozen foods. For example, a food storage unit may include a freezer section and a refrigeration section for maintaining food slightly above and slightly below freezing temperatures. The method may include the step of transferring the frozen product from a freezer to the microwave oven and an additional step to transfer the defrosted food to a conventional oven for cooking. In a still further step the transfer mechanism may be used to transfer the food from a refrigeration section to the conventional oven while a further step may be provided for transferring the cooked food to a warming oven or pick-up section.

A preferred embodiment of the invention contemplates a semi-automated system wherein a transfer from storage to a first piece of apparatus and from the first apparatus to a second apparatus and ultimately to a warming oven or pick-up counter are manual transfers. For a fully automated system a mechanism as described in the previously mentioned U.S. Pat. Nos. 8,145,854 or 8,712,851 can be employed. Those references are incorporated herein in their entirety by reference.

The invention will now be described in connection with the following drawings.

### DESCRIPTION OF THE DRAWINGS

FIG. 1 is a flowchart illustrating a system in accordance with a first embodiment of the invention; and

FIG. 2 is a flowchart illustrating a method in accordance with a second embodiment of the invention.

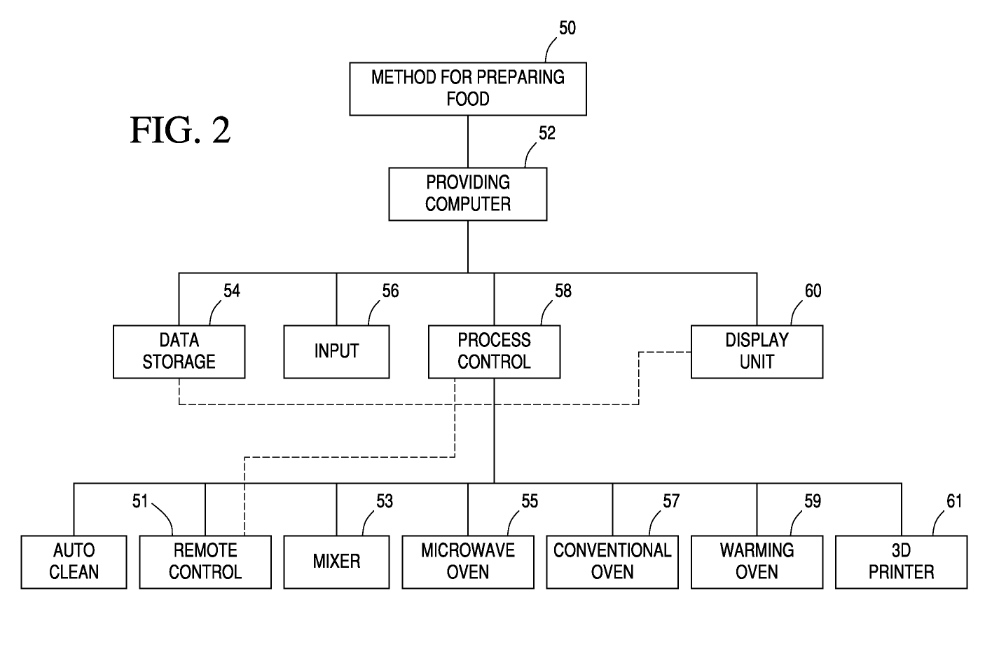

### DETAILED DESCRIPTION OF THE PREFERRED EMBODIMENTS OF THE INVENTION

A web based computer related system and method that completely automates the remote production with minimal human interaction is operable to perform operations including some common functions and some specialized functions. The method may include the steps of preparing product catalogues, making offered products ready for customer orders, real time remotely auditing of the performance and components of client-end production machinery, remote stock taking from raw material inventories available at the client-end machinery, editing of catalogues as per client end machinery features disclosing the maximum quantity to be produced, advice to online procure or install further raw material kits, remotely controlling, monitoring, auto cleaning, and maintenance of the client-end machinery to produce the ordered quantity through a step-by-step live transmission of encoded instructions, and to generate alert messaging and printing through client-end machinery.

Standard or hybrid machines including computer numerical control (CNC) machinery, 3D printing machinery, baking/cooking chef and food factory machinery and composite printing and binding machinery can be used by the system.

The products of branded and non-branded items can be included upon the achievement and fulfillment of the minimum standards and legal authorization of formulation and recipes of their branded products and to avoid re-production of copyright branded products.

A web based computer related system (methods/systems/apparatus including computer programs) that almost completely automate the production, composing and/or printing processes with minimum human interaction involved (human interaction may be limited to storing raw material(s) (kits) in designated storage areas, attachment of Internet, electricity, gas, water and fuel connections, high-level selection of components, features and computer interface(s), manual removal/serving of finished products from a prepared area, automatic cleaning and calibration) and operable to perform operations including some common functions (like taking input from common user interface, online registration of users and client site production machinery, taking customer orders online, online payments through common payment methods, home delivery of raw material kits through common courier services from nearest inventory store, sharing of common information, encoding and storing of data through web services), and some specialized functions including preparation of products catalogues recording, registration and encoding of the instructions, methods, procedures, techniques, formulation and recipes of products, components, modules, elements and list of raw material required for the production of minimum quantities and required machinery for the production and displaying a product catalogue and real time remote auditing of the performance and available components, features of production machinery installed at client end real-time remote stock taking of raw materials.

The client-end machinery to be used by the system can be standard or hybrid machines including (CNC) machinery, 3D printing machinery, baking/cooking chef and food factory machinery and composite printing and binding machinery.

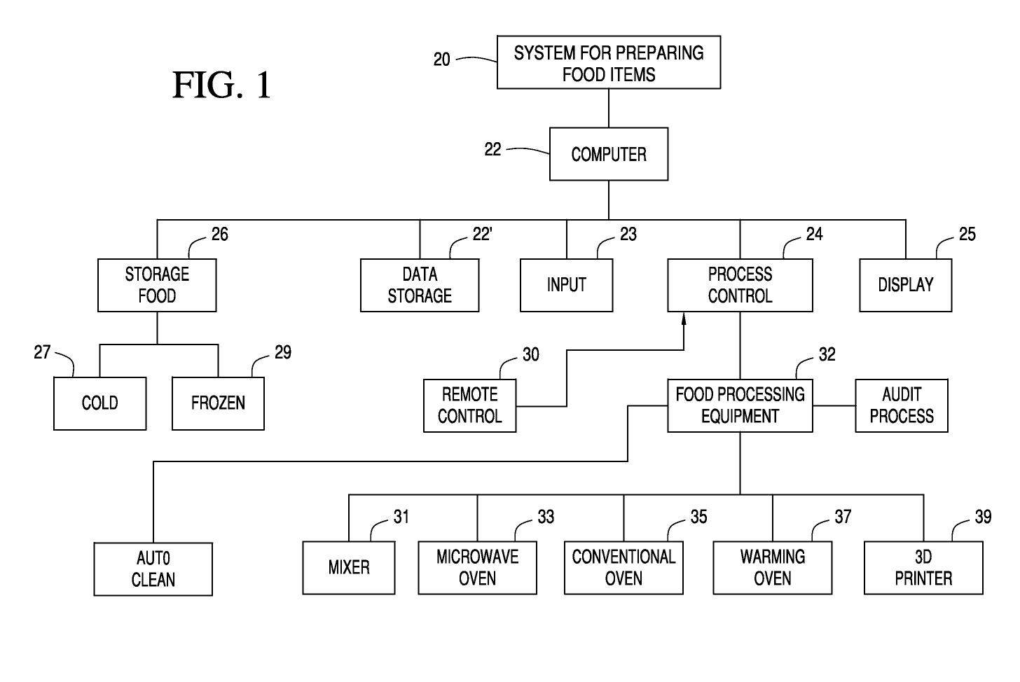

As illustrated in FIG. 1, a system 20 for preparing food such as one or more meals includes a computer 21 having data storage 22′, and an input device 23 such as a keyboard. The computer 21 also has a process controller 24 and a display device 25 or monitor that displays a list of food items in inventory and/or photos of cooked meal items. A food storage unit 26 is also connected to the computer 22 and indirectly connected to the process controller 24. The storage unit 26 is divided into a cold storage section 27 or refrigeration section that maintains food at a temperature slightly above freezing and a freezer 29.

The system 20 also includes a remote controller 30 that is operably connected to the process control unit 24 for selecting foods, menus and cooking instructions. The remote controller 30 is indirectly connected to the food processing equipment 32 by the process control unit 24 to override pre-programmed conditions. The food processing equipment may include a mixture 31, a microwave oven 33, a conventional oven 35, a warming oven 37 as well as a 3D food printer 39.

200. Real time remotely auditing (checking, testing) of the performance and available components, features of production machinery may be installed at the client-end.

300. Real-time remote stock taking of production related raw material inventory may also be stored along with the client-end machinery.

400. Filtration of catalogues as per client end machinery, installed features/components and suggesting to the clients about the maximum quantity to be produced as per available raw material (kits) or otherwise advised to procure or install further raw material kits.

500. Remotely controlling and monitoring of the client-end machinery to produce an ordered quantity through encoded instructions transmission step-by-step may also be provided.

600. Automatic cleaning of client-end machinery before and after use for production purposes through a remote transmission of instructions.

700. Remotely calibration of the client-end machinery.

800. Generate alert messaging and printing through client-end machinery are disclosed.

A method for semi-automatically preparing food or meals in accordance with a second embodiment of the invention includes the step of providing a computer 52 that further provides a data storage module 54, an input mechanism 56 for entering data into the data storage module 54. A processing control module 58 and a method for displaying information 60 are also provided.

The process control module 58 in response to a signal from the remote control 51 activates a mixer 53, microwave oven 55, conventional oven 57, warming oven 59 and 3D printer 61.

A program for the process controller 58 activates the processing equipment and transfer of a food item from food storage to various pieces of equipment. However, a semi-automated process for relies on human effort to transfer foods from a refrigerator and/or freezer to various pieces of food equipment, between various pieces of equipment, manual cleaning of the mixer, an addition of ingredients to the mixer and manual transfer to a warming oven. The semi-automated method is preferred for saving of space and cost for home use while a more fully automated embodiment may be more appropriate for a small restaurant or self-serving cafeteria.

While the invention has been described in connection with its preferred embodiments, it should be recognized and understood that changes and modifications may be incorporated herein without departing from the scope of the appended claims.

What is claimed is:

1. A remote controllable semi-automated system for offering and preparing food items, said system comprising:
a computer having data storage and an input mechanism for listing food items and locations in inventory and alternative menus in said data storage for all such foods, a processing control unit and a display unit for displaying the food items and preparation alternatives for each item available in inventory;
food processing equipment including a mixer, a microwave oven, a warming oven, a conventional oven, and a 3D food printer;
a remote control operatively connected to said computer for displaying items in inventory and alternate menus for such items and for initiating said processing control unit for activating said food processing control unit and said food processing equipment;
a storage unit for storing food containing the food items for a pre-planned meal;
a real time remotely auditing program for indicating available food and equipment for preparing a meal and for auditing the number of each offered food item in inventory;
a signal issuing timer and a signal issuing mechanism and program for remotely controlling and monitoring said food processing machinery to produce the ordered quantity of food items; and
a program for automatically cleaning the food processing equipment after a pre-selected menu.

2. The remote controllable semi-automated system for offering and preparing food items according to claim 1, which includes said microwave oven programmed for defrosting a frozen food and for pre-heating said conventional oven to a pre-selected temperature and issuing a signal to an individual to transfer the cooked food to a food pick-up area or a warming oven.

3. A remote controllable semi-automated system for offering and preparing food items, said system consisting of:
a computer having data storage and an input mechanism for listing food items and locations in inventory and alternative menus in said data storage for all such foods, a processing control unit and a display unit for displaying the food items and preparation alternatives for each item available in inventory;
food processing equipment including a mixer, a microwave oven, a warming oven, a commercial oven, and a 3D food printer;
a remote control operatively connected to said computer for displaying items in inventory and alternate menus for such items and for initiating said processing control unit for activating said food processing control unit and said food processing equipment;
a storage unit for storing food containing the food items for a pre-planned meal;
a real time remotely auditing program for indicating available food and equipment for preparing a meal and for auditing the number of each offered food item in inventory;
a signal issuing timer and a signal issuing mechanism and program for remotely controlling and monitoring said food processing machinery to produce the ordered quantity of food items; and
a program for automatically cleaning the food processing equipment after a pre-selected menu.

4. The remote controllable semi-automated system for preparing food items according to claim 3, which includes said microwave oven programmed for defrosting a frozen food and for pre-heating said conventional oven to a pre-selected temperature and issuing a signal to an individual to transfer the cooked food to a food pick-up area or a warming oven.

5. A remote controllable semi-automated method for offering and preparing food items, said method comprising:
providing a computer having data storage capacity and an input mechanism for inputting a plurality of food items and their locations in inventory and alternative menus in said data storage, a processing control unit and a display unit for displaying the available food items and alternative menus for items in inventory;
providing food processing equipment including a mixer, a microwave oven, a conventional oven, and a warming oven, a 3D food printer and a mechanism for issuing signals;
providing a remote control operatively connected to said computer for displaying items in inventory and alternative menus for such items and for initiating said processing control unit and said food processing control unit and said food processing equipment for preparing selected foods;
providing a storage unit for storing food containing food items required for a pre-planned meal; and
providing a real time remote auditing program for testing and checking the ovens.

6. The remote controllable semi-automated method for offering and preparing food items according to claim 5, which includes frozen food items preheating the conventional oven to cook the defrosted food and cooking defrosted food and signaling an individual that the food is ready to eat or to a warming oven.

7. The remote controllable semi-automated method for offering and preparing food items according to claim 6, and further consisting of real time remotely auditing available food components and food processing equipment to fill a given order; and remotely controlling said food processing equipment to cook said food and auditing said system to determine that the process has been properly completed.
